(19) United States
(12) Patent Application Publication
(10) Pub. No.: US 2005/0048172 A1
(43) Pub. Date: Mar. 3, 2005

(54) Compositions of legume proteins and methods of use thereof for reducing acrylamide in cooked foods

(76) Inventors: Dhiraj A. Vattem, Amherst, MA (US); Kalidas Shetty, Amherst, MA (US)

Correspondence Address: Patrick H. Higgins;Mathews, Collins, Shepherd & McKay, Suite 306, 100 Thanet Circle, Princeton, NJ, 08540, US

(21) Appl. No.: 10/743,400

(22) Filed: Dec. 22, 2003

Related U.S. Application Data
(60) Provisional application No. 60/499,551, filed on Sep. 2, 2003.

(51) Int. Cl. A23B 4/00

(52) U.S. Cl. 426/302

(57) ABSTRACT

A method of preparing food for cooking in oil is provided, to control production of acrylamide upon cooking the food in oil, comprising coating the food with an aqueous composition comprising about 0.2% (w/v) to about 40% (w/v) legume flour.

### FIELD OF THE INVENTION

The current invention is drawn toward compositions of legume proteins and methods of cooking food to control the production of acrylamide.

### BACKGROUND OF THE INVENTION

Acrylamide and its analogues can be formed by heating of biological material derived from plant tissues. This compound, identified long ago as a potential industrial hazard, has now been found in many cooked foods (Tareke, Rydberg, Karlsson, Eriksson, & Törnqvist, 2000; Tareke, Rydberg, Karlsson, Eriksson, & Törnqvist, 2002). The identification of acrylamide in heated foodstuffs originated with the discovery of the presence of acrylamide-hemoglobin adducts in blood of rats which were fed fried standard feed (Bergmark, Calleman, He & Costa, 1993). This led to the investigation on the effect of heating (frying etc.) on the content of acrylamide in different foodstuffs (Rosen & Hellenas, 2002).

Reports of the presence of acrylamide in a range of fried and oven-cooked foods have caused worldwide concern because of its probable carcinogenicity in humans. Extensive studies (Lijinsky & Andrews, 1981; Friedman, Dulak, & Stedham, 1995) have been done on acrylamide on its mutagenicity and carcinogenicity in bacterial, animal and human systems. The compound was found to be a weak inducer of SV 40 DNA amplification and potentiated the genotoxicity of chemical carcinogens (Spencer, & Schaumburg, 1974b). It was shown to produce skin and lung cancers in mice models (Hashimoto & Tanii, 1985; Vanhoric & Moens, 1983). Acrylamide is known to produce neuropathy in both human and experimental animals (Bull, et al., 1984; Bull, Robinson, Laurie & Strober, 1984; Ko, Chen, Lin-Shiau & Hsieh, 1999; Madrid, Ohnishi, Hachisuka, & Murai, 1993; Chapin, et al., 1995; Lehning, Persaud, Dyer, Jortner & LoPachin, 1998) and some of its analogues have been shown to cause testicular damage as well as neurotoxicity in experimental animals (Hashimoto, Sakamoto & Tanii, 1981).

Potato and processed potato products are widely consumed foods and their production constitute some of the largest food processing industries in the Western Hemisphere. The discovery of the formation of potentially carcinogenic acrylamide in starch foods poses a significant public-health and economic risk for the society. A recent study undertaken by two research groups independently have concluded that acrylamide was formed when certain amino acids and sugars were heated beyond 120° C. (Mottram D. S., Wedzicha B. L. & Dodson A. T, 2002; Stadler R. H., et al. 2002). The problem of complete extraction of acrylamide from potato chips was recently investigated. Pedersen J R, et al., Analyst. April 2003 128(4):332.

### SUMMARY OF THE INVENTION

The current invention is drawn toward compositions of legume proteins and a method of preparing food for cooking in oil, to control production of acrylamide upon cooking the food in oil, comprising providing a composition of legume proteins and coating the food with the composition of legume proteins.

### BRIEF DESCRIPTION OF THE FIGURES

FIG. 1 graphically illustrates the 5% MeoH soluble and water soluble phenolic content of white potato chips before and after treatment.

FIG. 2 graphically illustrates the DPPH Radical inhibition capacity and antioxidant protection factor of white potato chips before and after treatment.

FIG. 3 graphically illustrates the relationship between protein content and acrylamide content in white potato chips.

FIG. 4 shows the non-oxidative model for acrylamide synthesis in fried food stuff.

### DETAILED DESCRIPTION OF THE INVENTION

Unless defined otherwise, all technical and scientific terms used herein have the same meaning as is commonly understood by one of skill in the art to which this invention belongs. All publications and patents referred to herein are incorporated by reference.

The understanding of acrylamide formation and the study of methods for its reduction in foods has resulted in the development of improved technologies for processing high-starch foods such as potato and its products with reduced acrylamide. Particularly, the presence of legume proteins, due to their physical and chemical properties, are now discovered to reduce the formation of acrylamide in cooked foods.

Legume proteins may be derived from beans, peas, lentils, peanuts, blackgram or any member of the Leguminosae (Fabaceae) family. The term “pea” as used herein refers to all peas including chickpeas. Defatted powders (flours) are preferred. Chickpea, pea, soybean, mung bean, fava bean, defatted peanut, lentils, field bean, blackgram (urad dhal), black bean, Adzuki bean, pigeon pea, winged bean or any dietary legume in the family Leguminosae (Fabaceae). Preferable are chickpea, pea, soybean, mung bean, black gram, fava bean and field bean. Preferred combinations are chickpea or pea with soybean. Legume powders are combined employing 2, 3 or 4 different legumes, for example, to produce compositions with protein content from about 0.2% to about 40%. Individual legume flours may range, for example, anywhere from about 1% to about 100% of the dry flour compositions herein. The compositions can be fermented overnight with yeast, food fungi or lactic acid bacteria (after making a liquid paste with 1 to 10 volumes of water and inoculation). Example dry flour compositions for use in the present invention include, for example, but are not limited to, about 95% chickpea flour and about 5% soybean flour, about 90% chickpea flour and about 10% soybean flour, about 85% chickpea flour and about 15% soybean flour, about 80% chickpea flour and about 20% soybean flour, about 75% chickpea flour and about 25% soybean flour, about 70% chickpea flour and about 30% soybean flour, about 65% chickpea flour and about 35% soybean flour, about 60% chickpea flour and about 40% soybean flour, about 55% chickpea flour and about 45% soybean flour, about 50% chickpea flour and about 50% soybean flour, about 45% chickpea flour and about 55% soybean flour, about 40% chickpea flour and about 60% soybean flour, about 35% chickpea flour and about 65% soybean flour, about 30% chickpea flour and about 70% soybean flour, about 25% chickpea flour and about 75% soybean flour, about 20% chickpea flour and about 80% soybean flour, about 15% chickpea flour and about 85% soybean flour, about 10% chickpea flour and about 90% soybean flour, and about 5% chickpea flour and about 95% soybean flour. Example embodiment aqueous compositions of the present invention comprise pea (e.g., chickpea) and soybean.

Aqueous compositions described herein are fundamentally batter recipes for coating foods for frying or deep-frying. Particularly, however, the aqueous compositions (batter) of the present invention are effective in reducing the production of acrylamide during cooking. Cooking food in oil or deep frying generally proceeds at a temperature between about 160° C. and about 200° C. Maintaining an oil frying temperature between about 165° C. and about 175° C., preferably about 170° C., is a preferred cooking temperature to minimize formation of acrylamide during frying food in oil. Grob, K., French Fries with Less Than 100 Mg/Kg Acrylamide. A Collaboration Between Cooks and Analysts, European Food Research and Technology, 217(3):185 (2003). Oil for cooking as described herein includes, but is not limited to, canola oil, mustard oil, corn oil, soybean oil, rice barn, olive oil, palm oil, coconut oil, peanut oil, sunflower oil, safflower oil, and cotton seed oil. Embodiments of methods of preparing food, for example, are provided herein for cooking in oil, to control production of acrylamide upon cooking the food in oil, comprising coating the food with an aqueous composition comprising about 0.2% (w/v) to about 40% (w/v) legume flour, and cooking the food in oil while substantially maintaining an oil frying temperature between about 165° C. and about 175° C. during cooking. When potatoes and portions thereof, e.g., slices (French fries, for example, or potato chips), are prepared according to methods of the present invention, the substantially skinless portion is preferably washed (e.g., soaked in water (between about thirty seconds and about thirty minutes, depending upon the temperature) to extract asparagine and sugars from a surface of the portion of the potato before coating the food with the composition. The substantially skinless portion, in contrast to a whole potato, is an important aspect of the present invention to extract asparagine and sugars from a surface of the portion of the potato before coating the food with the composition, in order to greatly reduce the formation of acrylamide upon cooking in oil (preferably between about 165° C. and about 175° C.) as otherwise described herein. Washing in water may be, for example, between about 10 minutes and 20 minutes, for example, at room temperature (between about 20° C. and about 30° C.). Preferred foods for coating using compositions of the present invention include, but are not limited to, foods substantially composed of—or coated with a layer substantially composed of—potato, rice, wheat, corn, rye, cassava, banana, plantains, sorghum, millets, or barley. Other foods within the scope of the claims appended hereto include chicken, beef, fish, shellfish, and vegetables, including but not limited to carrots.

Aqueous compositions, for coating food to reduce acrylamide production upon cooking the food in oil, are preferred which comprise about 0.2% (w/v) to about 40% (w/v) legume flour wherein the legume flour comprises at least two flours selected from the group consisting of pea (e.g., chickpea), bean, lentil, peanut, and soybean. A method of preparing food for cooking in oil is provided to control production of acrylamide upon cooking the food in oil, comprising coating the food with an aqueous composition comprising about 0.2% (w/v) to about 40% (w/v) legume flour. A method of preparing and cooking food in oil to control production of acrylamide is provided, comprising coating the food with an aqueous composition comprising about 0.2% (w/v) to about 10% (w/v) legume flour, e.g., chickpea and soybean (exemplified supra); and, cooking the food in oil. Cooked food, selected from the group consisting of potato, rice, wheat, corn, rye, cassava, banana, plantains, sorghum, millets, barley, chicken, beef, fish, shellfish, and a vegetable is provided, prepared by a process comprising coating the food with an aqueous composition comprising about 0.2% (w/v) to about 10% (w/v) legume flour (e.g., chickpea and soybean); and, cooking the food in oil.

Aqueous compositions of the present invention, for coating food to reduce acrylamide production upon cooking the food in oil, comprise about 0.2% (w/v) to about 40% (w/v) legume flour as discussed supra and about 0.1% (w/v) to about 10% (w/v) of at least one cereal flour selected from the group consisting of wheat, oat, barley, and rye. Alternately, an aqueous composition of the present invention, for coating food to reduce acrylamide production upon cooking the food in oil, comprises about 0.2% (w/v) to about 40% (w/v) of a single legume flour, e.g., chickpea, and about 0.1% (w/v) to about 10% (w/v) of at least one cereal flour selected from the group consisting of wheat, oat, barley, rye, rice, and corn.

Sodium bicarbonate and potassium bitartrate, the well-known baking soda components, can be used in compositions of the present invention as is well known to those skilled in the art of mixing batter for preparing foods for deep frying.

Legume proteins are particularly valuable in reducing the formation of acrylamide in cooked foods that are high in starch. Examples of cooked food high in starch or starch coating, include, but are not limited to, foods derived from potatoes, corn, wheat, barley, rye, and rice.

Accordingly, potato chips, French fries, pasta, breaded foods (e.g., enveloped, pie crusted, or deep fried battered foods) are intended inter alia to be within the scope of the present invention.

Acrylamide Formation is Non Oxidative in Nature

The formation of acrylamide was studied and is reported herein, for example, wherein potato slices were coated with chickpea batter and fried. The formation of acrylamide in fried potato chips is not an oxidative phenomenon and can be reduced by protective effects of chickpea proteins. The inhibitory effect of the proteins from legumes surprisingly indicates that Maillard reaction is not the controlling pathway resulting in the formation of acrylamide.

Particularly, in order to study the formation of acrylamide in cooked high starch foods, fried potato slices were treated either with phenolic antioxidants from cranberry and oregano or coated with protein-rich chickpea batter. The formation of acrylamide was not reduced or inhibited by the presence of phenolic antioxidants from cranberry and oregano extracts in the potato slices. The acrylamide content on the contrary increased when exogenous phenolics were present.

Acrylamide Content

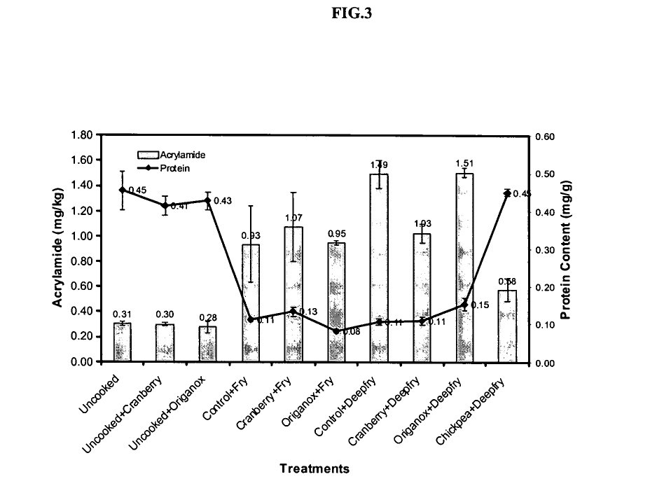

Acrylamide content was measured by HPLC-DAD. The base values for acrylamide content reported here (0.31 mg/kg) are surprisingly higher than reported previously in the literature (0.03 mg/kg). This could be due to climatic and varietal differences in the potatoes used for these studies as well as differences in the long post harvest storage (up to 9 months) and temperature which could influence the acrylamide formation in products made from them. The acrylamide content increased with the increase in frying time. However, the different phenolic treatments had no significant effect on the acrylamide formation at the uncooked stage. The increase in acrylamide content after frying was 3-fold, 3.5 fold and 3.4 fold for control, cranberry treated and oregano treated slices (FIG. 3) respectively, from the uncooked stage. There was a further increase in the acrylamide content after the slices were deep fried for 10 min. In the control, the acrylamide content increased from an initial value of 0.31 mg/kg to 1.49 mg/kg. For the cranberry treated slices it increased to 1.03 mg/kg and for oregano treated slices it increased to 1.51 mg/kg. When the slices were treated with chickpea batter and deep fried, the acrylamide content only increased to 0.58 mg/kg from an initial value of 0.31 mg/kg.

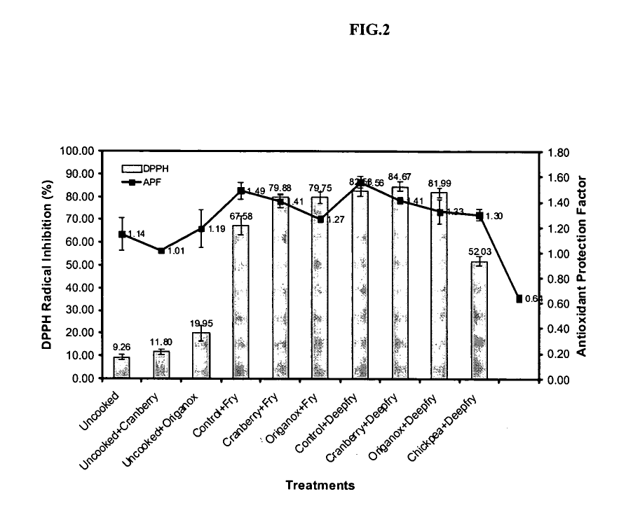

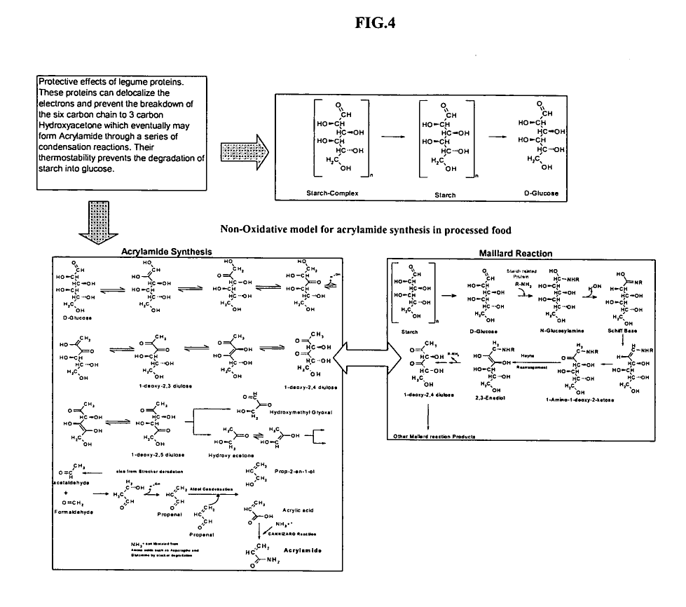

An increased antioxidant activity correlated with increased acrylamide formation in response to the external phenolic treatments (FIGS. 2 and 3). Also, when higher protein was present less acrylamide formation was observed, indicating the protective effects of legume proteins (FIG. 3). Accordingly, acrylamide formation is primarily non oxidative in nature. An illustrative reaction is shown to demonstrate the formation of acrylamide (FIG. 4). The degradation of glucose (Davudek, Velisek & Pokorny, 1990a) and Maillard reaction (Fujumaki, Namiki, & Kato, 1986).

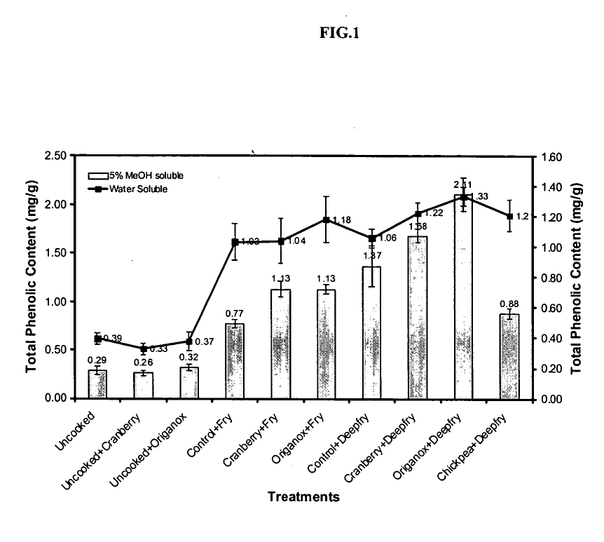

Higher temperatures cause dissociation of starch complexes in plant tissues, liberating “free” starch. This free starch can undergo degradation to form free sugars such as D-Glucose. D-Glucose, through a series of enolizations and isomerizations, can form a 2,4 deoxy sugar intermediate. Alternatively, the free sugar can also react with free amino acids to form Schiff's base, which represents the initiation of Maillard reaction. The imine base formed during this reaction can undergo Hayns-rearrangement to form the same 2,4 deoxy sugar formed by the degradation of D-Glucose and other simple sugars. The 2,4 deoxy sugar undergoes one more keto-enolization to form 2,5 deoxy dilulose. This sugar, being unstable, fragments into two 3-carbon compounds, hydroxyl acetone and hydroxymethyl glyoxal. Hydroxyl acetone being a hydroxyl-ketone quickly breaks down to form acetaldehyde and formaldehyde (Davudek, Velisek & Pokorny, 1990b). The acetaldehyde can also be obtained from the Strecker degradation (Belitz & Grosch, 1999; Paulsen & Pflughaupt, 1980; Martin, & Ames, 2001; Dembinski & Bany, 1991) of free amino acids already present in the potato or by the degradation of proteins to amino acids during heat treatment. Acetaldehyde and formaldehyde condense together and form an alkoxide which quickly loses one molecule of water to form 2-propenal. Two molecules of 2-propenal can undergo a Cannizaro reaction to form acrylic acid and 2-propenol. Acrylic acid can then react with the ammonium base released from Strecker degradation of asparagine and glutamine amino acids in potato to form acrylamide (FIG. 4). The total phenolic content and the antioxidant activity of both the 5% methanol and water extracts of the potato slices increased with the frying time (FIG. 1). Frying also increased the antioxidant capacity of the potato extracts (FIG. 2). The increased antioxidant capacity when the chips were fried could be due to increase in the formation of Maillard reaction products which are known to have antioxidant properties (Yoshimura, Iijima, Watanabe & Nakazawa, 1997) Waller & Feather, 1983) In the later stages, Maillard reaction forms heterocylic compounds which may interfere with the Folin-Ciocalteu assay and may be the cause of increase in measurable phenolics.

Presence of chickpea coating on the slices resulted in lower amounts of phenolics when deep fried (FIG. 1). The acrylamide content (FIG. 3) increased with the increase in phenolic content (FIG. 1) and antioxidant capacity (FIG. 2) during frying. This indicates that acrylamide formation is directly related to the degradation of sugars and Maillard reaction during frying. The increase in antioxidant activity directly corresponded to the increase in the acrylamide content which may be due to the formation of increased Maillard reaction intermediates. This indicates that acrylamide formation is primarily a non oxidative phenomenon. This is further substantiated by the fact that the treatment with known phenolic antioxidants stimulated the formation of acrylamide with oregano or did not reduce or inhibit with cranberry extracts. In potato and other plants having high starch, starch granules are usually complexed to the lipids, proteins and to other biological polymers that are present in the tissue (Waller & Feather, 1983). The phenolics are known to bind to proteins (Seibert, Troukhanova, & Lynn, 1996) and alter their tertiary structure and also disrupt the starch-lipid complex due to their partial hydrophobicity. Therefore, the phenolics from cranberry and oregano powder may be in some ways interacting with the proteins and present in the starch-protein complex and the starch-lipid complex during the treatment and result in the dissociation of the stable starch complexes. This dissociation may make the starch more available for reactions with proteins and for thermal degradation when fried, which would have resulted in higher formation of Maillard products when the slices were treated with cranberry and oregano extracts. This is further substantiated by the lower formation of phenolics and antioxidants in the control slices where no phenolics were added exogenously (FIG. 1). The dissociation of starch protein complex in the presence of phenolics could also be the probable cause for higher acrylamide formation in these phenolic treated slices. Increased Maillard reaction may be producing intermediates which are channeled for acrylamide formation (FIG. 4). Protein content of the fried samples was inversely proportional to the acrylamide formation in the fried slices where protein decreased during frying and this corresponded to an increase in acrylamide formation. Proteins in chickpea and other legumes are known to be heat stable and their function to act as thermal barriers is well established (Milán-Carrillo, Reyes-Moreno, Armienta-Rodelo, Carábez-Trejo, & Mora-Escobedo, 2000). Lower phenolic content, reduced DPPH antioxidant activity and therefore lower acryamide content was realized when chickpea was used. The proteins also complex starch on the surface of the slices and stabilize the complex even at higher temperatures encountered during frying. A stable starch-protein complex makes the sugars in the starch less available for Maillard reaction and thermal degradation and therefore, less acrylamide is formed. Maillard reaction and degradation of sugars is known to increase with temperature and time of thermal processing. The legume proteins also delocalize the electrons from the carbonyl carbon on the sugar via their aromatic amino acids. This delocalization prevents the keto-enolization of the sugars and therefore, breakdown of the six carbon chain to 3 carbon hydroxyacetone which eventually may form acrylamide through a series of condensation reactions.

Protein Content

Changes in protein content were measured when the slices were treated and fried. It was observed that there was a rapid loss in the measurable protein by Bradford dye-binding assay (FIG. 3). The protein content decreased by almost 75% to a value of ˜0.12 mg/g for control, cranberry and oregano treated slices after frying. Increase in frying time from 5 min to 10 min did not cause any further decrease. The slices treated with chickpea, which were deep-fried had 0.45 mg/g of protein which was similar to the uncooked slices.

Antioxidant Capacity of the Extracts

Antioxidant activity was measured in the 5% methanol extracts by both β-carotene linoleic acid oxidation system and by DPPH radical inhibition capacity (DRIC). The antioxidant capacity measured by the DPPH method was lower for the uncooked samples and ranged from 9-19% free radical inhibition (FIG. 2). The free radical inhibition capacity however, increased when the slices were fried. For the control, this increased from an initial value of 9.25% to 68%, the increase was almost 69% for the cranberry treated sample and 60% for the oregano treated slices. The DRIC increased further when the slices were deep fried and this increase was in the range 75-80% for control, cranberry treated and oregano treated slices.

The DRIC when the potato was treated with chickpea batter was only 52%, which corresponded to an increase of 43% from initial values.

The antioxidant protection factor (APF) measured by the β-carotene linoleic acid oxidation system for the extracts increased with increase in frying time (FIG. 2). This increase was however highest for the untreated sample which had increased to a value of 1.49 after frying and 1.56 after deep frying from an initial value of 1.14. No significant differences in APF were observed when the cranberry, oregano and chickpea treated slices were fried or deep fried.

Total Phenolic Content

Total water soluble and 5% methanol soluble phenolic content was measured in the potato extracts. The total phenolics both in water and 5% methanol soluble extracts were higher in the extracts after frying. The total phenolic content ranged from 0.26-0.39 mg/g for the uncooked samples in 5% methanol extracts (FIG. 1). In the 5% methanol extracts, the phenolic content increased with heat treatment. For potatoes that were fried for 5 min, the phenolic content increased 3-fold for the untreated sample and by 4-fold for samples treated with extracts of oregano and cranberry. When the slices were deep fried, the phenolic content of the untreated potato slices increased almost by 4-fold compared to the uncooked slice. This increase was almost 6.5-fold for the cranberry treated sample and 7-fold for the oregano treated sample. When the slices were fried after treating it with chickpea batter, this increase was only 3-fold compared to the uncooked slices. In the water extracts, the change in phenolics (FIG. 1) after the different treatments and frying were similar to the 5% methanol extracts except that the difference in frying time did not result in more water extractable phenolics and there was no significant difference in the phenolics between the 3 different treatments when the chips were deep fried. However, the phenolics extracted from the oregano treated sample were much higher than others in both fried and deep fried samples.

### EXAMPLES

Chip Making

White Russet potatoes obtained from a local supermarket were sliced using an automatic slicer to ˜3mm thickness. Three kinds of treatments were given to the potato slices before they were fried. The first set of slices was soaked in water and was treated as control for the investigation. The second set of slices was soaked in 1% (w/v) Cranberry powder (Decas Cranberry products, Wareham, Mass.) and 1% (w/v) OriganoX (Barrington Nutritionals, Harrison, N.Y.). The third set of chips was dipped in 2% (w/v) solution of chickpea flour (obtained from local supermarket) before frying. Frying was done in Canola oil for 5 min and 10 min. The 5 min fried sample was referred to as “fried” and the 10 min fried sample was referred to as “deep fried”. The slices dipped in chickpea batter were only “deep fried”. Uncooked samples which were both treated and untreated were also analyzed to determine the basal level of the parameters analyzed.

Water Extraction

15 g of slices were weighed and crushed in a Waring Blender. 5 g of the crushed slices were mixed with 50 ml of distilled water. After shaking at 100 rpm for 30 min the sample was centrifuged at 9000 rpm for 30 min at 4° C. The supernatant was transferred into a 100 ml separating funnel and allowed to stand for 20 min to allow the aqueous and lipid layer to separate. The aqueous layer was removed and used for analysis.

5% Methanol Extraction

15 g of slices were weighed and crushed in a Waring Blender. 5 g of the crushed slices were mixed with 50 ml of 5% MeOH. After shaking at 100 rpm for 30 min the sample was centrifuged at 9000 rpm for 30 min at 4° C. The supernatant was transferred into a 100 ml separating funnel and allowed to stand for 20 min to allow the aqueous and lipid layer to separate. The aqueous layer was removed and used for analysis.

Protein Assay

Protein content was measured by the spectrophotometric method of Bradford assay (Bradford, 1976). 5 ml of diluted dye reagent (Bio-Rad protein assay kit II, Bio-Rad Laboratory, Hercules, Calif.) was added to 100 μl of the water extract. The absorbance was measured at 595 nm against a 5 ml reagent blank and 100 μl buffer using a UV-VIS Genesys spectrophotometer (Milton Roy, Inc., Rochester, N.Y.).

Total Phenolics Assay

The water extracts and ethanol extracts of the chips used for the phenolic assay. The total phenolics were determined spectrophotometrically by Folin-Ciocalteu assay modified from Shetty, Curtis, Levin, Witkowsky, & Ang (1995). The absorbance values were converted to total phenolics and were expressed in milligrams equivalents of gallic acid per grams of the sample. Standard curves were established using various concentrations of gallic acid in 95% ethanol.

Determination of Antioxidant Activity

### 1,1-diphenyl-2-picrylhydrazyl radical (DPPH) inhibition system (Cervato, Carabelli, Gervasio, Cittera, Cazzola, & Cestaro, 2000)

To 3 ml of 60 μM DPPH in ethanol, 500 μl of methanol extracts were added, the decrease in absorbance was monitored at 517 nm until a constant reading was obtained. The readings were compared with the controls, which contained 500 μl of 95% ethanol instead of the extract. The % inhibition was calculated by:

$$\% inhibition = \{ ( {A}_{517}^{control} - {A}_{517}^{extract} ) / {A}_{517}^{control} \} \times 100$$

### β-Carotene oxidation model system (Hammerschmidt, & Pratt, 1978)

One milliliter of 200 μg/ml of β-carotene in chloroform was pipetted into a round-bottomed flask. Chloroform was evaporated using a rotary evaporator under vacuum at 40° C. for 5 min. The β-carotene adhered to the sides of the flask were scraped and dissolved with 20 μl of purified linoleic acid and 184 μl of Tween 40 emulsifier. To this, 50 ml of 50 mM H₂O₂ was added and shaken vigorously until a uniform emulsion was obtained. 5 ml of this emulsion were transferred to each test tube containing 100 μl of extract. The samples were incubated at 50° C. for 30 min. Subsequently, absorbance readings were recorded at 470 nm and compared to a control which had 100 μl of ethanol in place of the extract. The antioxidant activity was expressed as protection factor (PF) and was calculated as follows:
Antioxidant protection factor (APF)=A₄₇₀ Sample/A₄₇₀ Control
HPLC Analysis of Acrylamide (OSHA; US EPA; US-FDA, 2002).

The 5% methanol extract was taken and centrifuged at 13000 rpm for 5 min in a mini centrifuge. The supernatant was carefully removed with a syringe and filtered thru a 0.2μ PVDF filter. The OASIS SPE cartridge which was conditioned with 5 ml methanol, followed by 5 ml of water was loaded with 2 ml of the extract. The extracts were allowed to pass completely through the sorbent material, and then eluted with 2 ml of water. The eluant from this column was collected for HPLC-DAD analysis. Acrylamide was eluted isocratically with 5% methanol, 95% water and chromatograms recorded at 200 nm, 214 nm, 240 run.

All publications and patents mentioned in the above specification are herein incorporated by reference. Various modifications and variations of the described compositions and methods of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described compositions and modes for carrying out the invention which are obvious to those skilled in the art or related fields are intended to be within the scope of the following claims.

1. An aqueous composition, for coating food to reduce acrylamide production upon cooking the food in oil, comprising about 0.2% (w/v) to about 40% (w/v) legume flour and about 0.1% (w/v) to about 10% (w/v) of at least one cereal flour selected from the group consisting of wheat, oat, barley, rye, rice, and corn.

2. A composition according to claim 1 wherein the legume flour comprises pea flour.

3. A composition according to claim 1 wherein the legume flour is at least one flour selected from the group consisting of bean, lentil, peanut, and soybean.

4. A composition according to claim 1 comprising about 0.5% (w/v) to about 10% (w/v) legume flour and about 0.1% (w/v) to about 10% (w/v) wheat flour.

5. A composition according to claim 3 comprising about 0.5% (w/v) to about 10% (w/v) legume flour and about 0.1% (w/v) to about 10% (w/v) wheat flour.

6. A composition according to claim 4 further comprising at least one component selected from the group consisting of sodium bicarbonate and potassium bitartrate.

7. A composition according to claim 4 comprising about 0.5% (w/v) to about 5% (w/v) legume flour and about 0.1% (w/v) to about 5% (w/v) wheat flour.

8. A method of preparing food for cooking in oil, to control production of acrylamide upon cooking the food in oil, comprising coating the food with an aqueous composition comprising about 0.2% (w/v) to about 40% (w/v) legume flour and about 0.1% (w/v) to about 10% (w/v) of at least one flour selected from the group consisting of wheat, oat, barley, rye, rice, and corn.

9. A method according to claim 8 wherein the composition comprises about 0.5% (w/v) to about 5% (w/v) legume flour and about 0.1% (w/v) to about 5% (w/v) wheat flour.

10. A method according to claim 9 wherein the food is selected from the group consisting essentially of potato, rice, wheat, corn, rye, cassava, banana, plantains, sorghum, millets, and barley.

11. A method according to claim 10 wherein the food is a portion of a potato.

12. A method according to claim 10 wherein the food is pasta, dough, bread, or cake.

13. A method according to claim 9 wherein the food is selected from the group consisting essentially of chicken, beef, fish, or shellfish.

14. A method according to claim 9 wherein the food is a vegetable.

15. A method according to claim 11 wherein the food is washed to extract asparagine and sugars from a surface of the food before coating the food with the composition.

16. A method of preparing and cooking food in oil, to control production of acrylamide, comprising coating the food with an aqueous composition comprising about 0.2% (w/v) to about 10% (w/v) legume flour and about 0.1% (w/v) to about 5% (w/v) of at least one flour selected from the group consisting of wheat, oat, barley, rye, rice, and corn; and, cooking the food in oil.

17. A method according to claim 16 wherein the food is selected from the group consisting of potato, rice, wheat, corn, rye, cassava, banana, plantains, sorghum, millets, barley, chicken, beef, fish, shellfish, and a vegetable.

18. A method according to claim 17 wherein the food is a portion of a potato.

19. A method according to claim 18 wherein the food is washed to extract asparagine and sugars from a surface of the food before coating the food with the composition.

20. Cooked food, selected from the group consisting of potato, rice, wheat, corn, rye, cassava, banana, plantains, sorghum, millets, barley, chicken, beef, fish, shellfish, and a vegetable, prepared by a process comprising coating the food with an aqueous composition comprising about 0.2% (w/v) to about 10% (w/v) legume flour and about 0.1% (w/v) to about 5% (w/v) of at least one flour selected from the group consisting of wheat, oat, barley, rye, rice, and corn; and, cooking the food in oil.

21. Cooked food according to claim 20 wherein the food is a portion of a potato and the portion is washed to extract asparagine and sugars from a surface of the portion before coating the portion with the composition.

22. An aqueous composition, for coating food to reduce acrylamide production upon cooking the food in oil, comprising about 0.2% (w/v) to about 40% (w/v) legume flour wherein the legume flour is at least one flour selected from the group consisting of bean, lentil, peanut, and soybean.

23. A composition, according to claim 22 wherein the legume flour comprises at least two flours selected from the group consisting of bean, lentil, peanut, and soybean.

24. An aqueous composition, for coating food to reduce acrylamide production upon cooking the food in oil, comprising about 0.2% (w/v) to about 40% (w/v) legume flour wherein the legume flour comprises at least two flours selected from the group consisting of pea, bean, lentil, peanut, and soybean.

25. A composition, according to claim 24 wherein the legume flour comprises pea and soybean.

26. A method of preparing and cooking a substantially skinless portion of a potato in oil, to control production of acrylamide, comprising washing the portion to extract asparagine and sugars from a surface of the substantially skinless portion, coating the portion with an aqueous composition comprising about 0.2% (w/v) to about 40% (w/v) legume flour; and, cooking the portion in oil.
